(19) United States
(12) Patent Application Publication
(10) Pub. No.: US 2026/0222056 A1
(43) Pub. Date: Jul. 30, 2026

(54) ENERGY-EFFICIENT FREQUENCY MEASUREMENT IN AN NTN CELL

(71) Applicant: Google LLC, MOUNTAIN VIEW, CA (US)

(72) Inventors: Ming-Hung TAO, Taoyuan City (TW); Chih-Hsiang WU, Taoyuan City (TW)

(21) Appl. No.: 19/149,010

(22) PCT Filed: Jan. 5, 2024
(86) PCT No.: PCT/US2024/010509

§ 371 Date: Jul. 17, 2025

Related U.S. Application Data
(60) Provisional application No. 63/439,859, filed on Jan. 18, 2023.

(51) Int. Cl. H04B 7/185

(52) U.S. Cl. CPC H04B 7/18513

(57) ABSTRACT

To perform inter-frequency measurements, a UE in an NTN cell receives a reference location of the NTN cell and one or more pairs of (i) a TN frequency, and (ii) a bitmap indication identifying one or more of a plurality of segments of the NTN cell with which the TN frequency is associated, the plurality of segments being determined by dividing the NTN cell in N sectors around the reference location, when the bitmap indication includes N bits. The UE searches for a TN cell on the TN frequency only if a current location of the UE is within the one or more of the plurality of segments with which the TN frequency is associated according to the bitmap indication.

This document relates generally to wireless communications and, more particularly, to energy- and/or bandwidth-saving techniques that a user equipment (UE) operating in the idle or inactive state in a non-terrestrial (NTN) cell can use when performing inter-frequency measurements.

### BACKGROUND

This background section is provided for the purpose of generally presenting the context of the techniques described in the following sections. Work of the presently named inventors, to the extent it is described in this background section, as well as aspects of the description that may not otherwise qualify as prior art at the time of filing, are neither expressly nor impliedly admitted as prior art.

The objectives behind developing the fifth generation (5G) technology include providing a unified framework for such types of communication as enhanced mobile broadband (eMBB), ultra-reliable low-latency communications (URLLC), and massive machine type communication (mMTC).

The 5G technology relies primarily on legacy terrestrial networks. However, the 3rd Generation Partnership Project (3GPP) organization has proposed to extend 5G communications to non-terrestrial networks (NTNs) with 5G new radio (NR) technologies, or with the Long-Term-Evolution (LTE) technologies tailored for the Narrowband Internet-of-Thing (NB-IoT) or the enhanced Machine Type Communication (eMTC) scenarios. In an NTN, an RF transceiver is mounted on a satellite, an uncrewed aircraft system (UAS) also referred to as drone, balloon, plane, or another suitable apparatus. For simplicity, the discussion below refers to all such apparatus as satellites. In addition to satellites, an NTN can include one or more satellite gateways (shorter called sat-gateways or NTN gateways) that connect the NTN to a public data network, feeder links between sat-gateways and satellites, service links between satellites, and inter-satellite links (ISL) when satellites form constellations.

A satellite can belong to one of several types based on altitude, orbit, and beam footprint size. The types include Low-Earth Orbit (LEO) satellite, Medium-Earth Orbit (MEO) satellite, Geostationary Earth Orbit (GEO) satellite, UAS platform (including High Altitude Platform Station (HAPS), and High Elliptical Orbit (HEO) satellite. GEO satellites are also known as the Geosynchronous Orbit (GSO) satellites, and LEO/MEO satellites are also known as non-GSO (NGSO) satellites.

A GSO satellite communicates with one or several sat-gateways deployed over a satellite targeted coverage area (e.g. a region or even a continent). A non-GSO satellite temporarily communicates with one or several serving sat-gateways. An NTN is designed to ensure service and feeder link continuity between successive serving sat-gateways, with sufficient overlapping time to proceed with mobility anchoring and hand-over.

A satellite may generate several beams for a given service area bounded by the field of view. The footprints of the beams depend on the on-board antenna configuration and the elevation angle and typically have an elliptic shape. A satellite may support a transparent or a regenerative (with on board processing) payload scheme. For a transparent payload scheme, a satellite may apply RF filtering and frequency conversion and amplification, without changing the waveform signal. For a regenerative payload scheme, a satellite may apply RF filtering, frequency conversion and amplification, demodulation and decoding, routing, and coding/modulation. This regenerative approach is effectively equivalent to implementing most of the functions of a base station (e.g., a gNB in 5G systems).

NB-IoT and eMTC technologies are expected to be particularly suitable for IoT devices operating in remote areas with limited or no terrestrial connectivity. Such IoT devices can be used in a variety of industries including for example transportation (maritime, road, rail, air) and logistics; solar, oil, and gas harvesting; utilities; farming; environmental monitoring; and mining. However, to ensure the required IoT connectivity, deployment of these technologies requires satellite connectivity to provide coverage beyond terrestrial deployments. Satellite NB-IoT or eMTC is defined in a complementary manner to terrestrial deployments.

A UE may receive better service in a TN cell than in an NTN cell. When camping in an NTN cell, the UE measures signals in TN cells to determine whether cell reselection is available. More specifically, a UE camping on a cell operates in the idle or inactive state associated with the Radio Resource Control (RRC) sublayer of the radio protocol stack and monitors only control information in the cell. The UE does not have an active radio connection with a base station in the idle state (RRC_IDLE), and the radio connection in the inactive state (RRC_INACTIVE) is suspended at least temporarily. Because an idle or inactive UE has no active radio connection with a base station, the UE relies on control information in the NTN cell to determine the frequencies of the TN cells which the UE can consider for a cell reselection.

Thus, the base station associated with the NTN cell transmits a system information block (SIB) including a list of cell identifiers and carrier information for the corresponding TN cells. However, an NTN cell generally covers a much larger geographic area than any single TN cell. Therefore, a UE may retrieve, from the SIB, information related to cells that the UE cannot detect at its current geographic location. In particular, the UE may attempt measurements at the frequencies included in the SIB but, due to the distance to the terrestrial base station, fails to detect the corresponding signals. The UE thus unnecessarily expends power.

It is possible for the base station to include, in a SIB, detailed geographic information for the TN cells. Using the detailed geographic information for a certain TN cell, a UE may determine whether the UE is sufficiently proximate to the corresponding terrestrial base station to attempt measurements. However, this approach requires a large signaling overhead because the non-terrestrial base station must transmit a large amount of additional information in a system information block.

### SUMMARY

The problems described in the background section are overcome by a UE method for performing inter-frequency measurements according to an embodiment. The UE method (i.e., performed by a UE) includes: receiving, in an NTN cell, (i) a TN frequency, and (ii) an indication of one or more of a plurality of segments of the NTN cell with which the TN frequency is associated; and searching for a TN cell on the TN frequency only if a current location of the UE is within the one or more of the plurality of segments.

According to another embodiment, a method performed by a base station associated with an NTN cell, for configuring inter-frequency measurements at a UE operating in the NTN cell includes: transmitting, in the NTN cell, a TN frequency; and indicating, in the NTN cell, with which one or more of a plurality of segments of the NTN cell the TN frequency is associated, to facilitate a search for a TN cell on the TN frequency at the UE.

Yet another example embodiment of these techniques is another UE method for performing inter-frequency measurements. The method performed by a UE includes: receiving, in an NTN cell, a frequency on which the UE is to search for a cell; and searching for a TN cell on the frequency, with a first time period; in response to detecting the TN cell on the frequency, measuring a signal in the TN cell, with a second time period.

Still another example embodiment of these techniques is a device comprising a transceiver; and a processing component configured to implement any of the methos above.

### BRIEF DESCRIPTION OF THE DRAWINGS

FIG. 1 is a block diagram of an example wireless communication system in which a user device of this disclosure can implement inter-frequency measurement techniques;

FIG. 2 is a block diagram of an example protocol stack according to which the UE of FIG. 1 communicates with base stations;

FIG. 3A is a block diagram of an example NTN node with transparent payload implementation;

FIG. 3B is a block diagram of an example NTN implementation in which a base station connects to multiple satellites via the same sat-gateway;

FIG. 4A illustrates an example user plane protocol stock for use with the architecture of FIG. 3A;

FIG. 4B illustrates an example control plane protocol stock for use with the architecture of FIG. 3A;

FIG. 5 is a diagram illustrating how a network can configure a UE to search for TN cells on TN frequencies, when the UE is in the idle or inactive state and is camping on an NTN cell;

FIG. 6A is a diagram illustrating how a base station can indicate, in an NTN cell and using a bitmap, coarse TN cell coverage;

FIG. 6B illustrates a scenario similar to that of FIG. 6A, with a logical divisional of the NTN cell into a larger number of segments;

FIG. 7 is a messaging diagram of an example scenario in which a UE performs a search and measurements on a TN frequency in response to determining proximity to a TN cell using the bitmap in the NTN cell;

FIG. 8 is a messaging diagram of an example scenario in which a UE foregoes a search and measurements on a TN frequency in response to determining non-proximity to a TN cell using the bitmap in the NTN cell;

FIG. 9 illustrates a scenario similar to that of FIG. 7, but here the UE also modifies the time period for searching on a TN frequency;

FIG. 10 illustrates a scenario similar to that of FIG. 7, but here the UE also obtains detailed coverage information for a TN cell, using an RRC resume procedure;

FIG. 11 illustrates a scenario similar to that of FIG. 7, but here the UE also obtains detailed coverage information for a TN cell, using a message exchange over an active radio connection;

FIG. 12 illustrates a scenario similar to that of FIG. 7, but here the UE also obtains detailed coverage information for a TN cell, using an on-demand SI acquisition procedure;

FIG. 13 is a flow diagram of an example method in a UE for determining whether to use a TN carrier frequency, based on coarse TN coverage information in an NTN cell;

FIG. 14 is a flow diagram of an example method in a UE for determining whether to use a TN carrier frequency and apply a modified measurement requirement, based on coarse TN coverage information in an NTN cell;

FIG. 15 illustrates a method similar to that of FIG. 14, but with the UE requesting detailed coverage information for a segment of the NTN cell, using an RRC resume procedure;

FIG. 16 illustrates a method similar to that of FIG. 14, but with the UE requesting detailed coverage information for a segment of the NTN cell, using messaging over an active radio connection;

FIG. 17 illustrates a method similar to that of FIG. 14, but with the UE requesting detailed coverage information for a segment of the NTN cell, using an on-demand SI acquisition procedure;

FIG. 18 is a flow diagram of an example method implemented in a base station for determining the coarse TN coverage information and broadcasting the coarse TN coverage in a system information block;

FIG. 19 is a flow diagram of an example method implemented in a base station for delivering detailed TN coverage information to a UE using an RRC Resume procedure;

FIG. 20 is a flow diagram of an example method implemented by a base station for delivering detailed TN coverage information to a UE in a DL DCCH message;

FIG. 21 is a flow diagram of an example method implemented by a base station for delivering detailed TN coverage information to a UE in an on-demand system information transmission;

FIG. 22 is a flow diagram of an example method implemented in a UE for determining the periodicity with which the UE is to search for TN cells on a TN frequency, or conduct measurement on a TN cell;

FIG. 23 is a flow diagram of an example method implemented in a UE for determining the periodicity with which the UE is to search for cells on a frequency based on whether the frequency is a TN frequency or an NTN frequency;

FIG. 24 is a flow diagram of an example method implemented in a UE for determining whether the UE should search for a TN cell based on the TN cell location information; and

FIG. 25 is a flow diagram of an example method that implemented in a UE for determining whether the UE should search for cells on a TN frequency, based on the location information associated with the TN frequency.

### DETAILED DESCRIPTION OF THE DRAWINGS

To reduce the overhead associated with transmitting detailed coverage information for TN cells (such as the centroid of a TN cell or the radius of coverage), a base station transmits, in an NTN cell, a compact indication of a segment or portion of the NTN cell in which the TN cell operates. For example, the base station and a UE can share a configuration according to which a TN cell consists of exactly N segments, which can be circular segments of equal size, and according to which the base station and the UE can unambiguously identify the segments. When the base station transmits system information indicating TN frequencies on which a UE can search for TN cells within the NTN cell, the base station attaches the compact indication to each TN frequency. The UE then uses the TN frequency for searching and/or measurement only if the UE is disposed within the corresponding segment (or if the UE is sufficiently proximate to the segment).

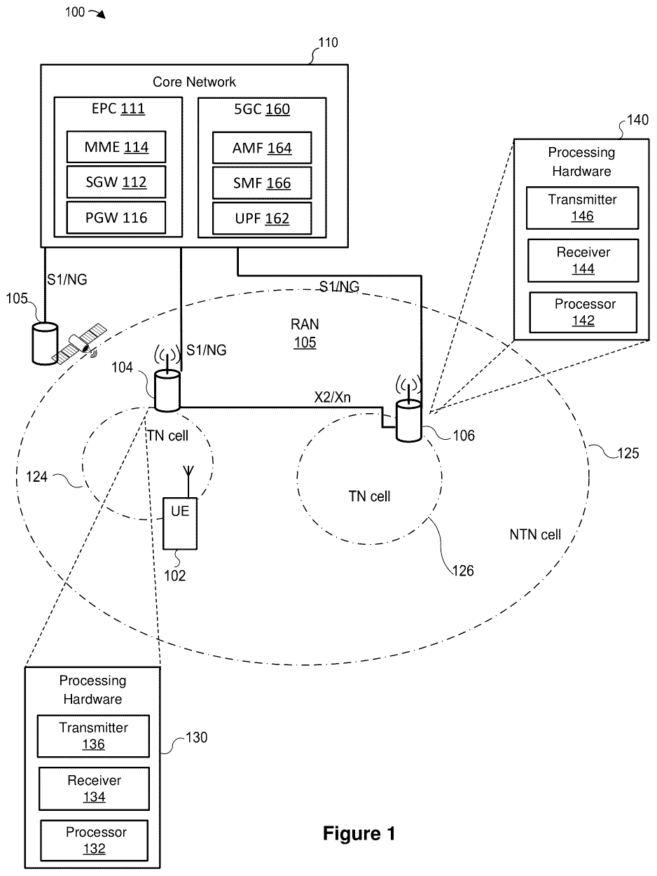

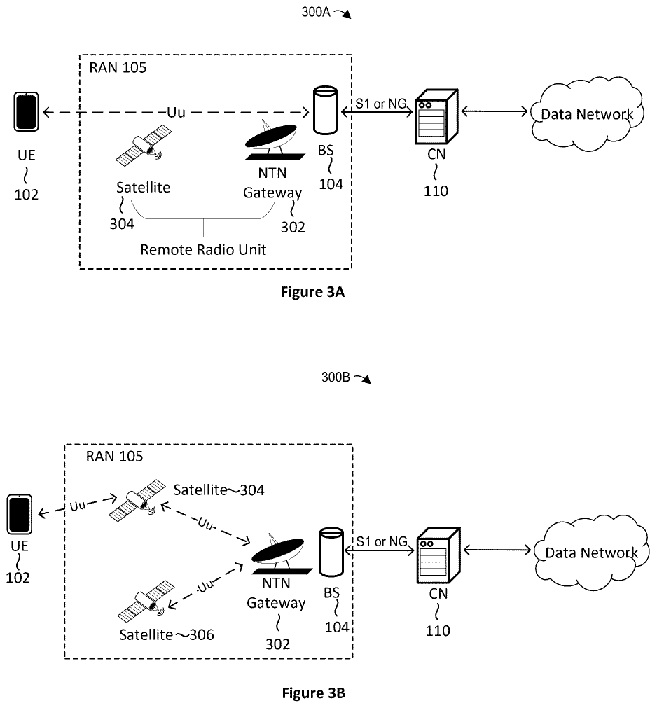

Referring first to FIG. 1, an example wireless communication system 100 includes a UE 102, a TN base station (BS) 104, a TN base station 106, an NTN base station 105 associated with a satellite (as will be discussed in more detail with reference to FIGS. 3A and 3B), and a core network (CN) 110. The base stations 104, 105, and 106 operate in a RAN 105 connected to the CN 110 and other base station components. The CN 110 can be implemented as an evolved packet core (EPC) 111 and/or a fifth generation (5G) core (5GC) 160, for example. The CN 110 can also be implemented as a sixth generation (6G) core and future evolutions.

The base station 104 covers a TN cell 124, and the base station 106 covers a TN cell 126. The base station 105 covers an NTN cell 125, which is significantly larger than the TN cells 124 and 126. The TN cells 124 and 126 can be disposed completely or partially within the NTN 125, so that the UE 102 operating in the connected state can perform a handover from the NTN base station 105 to the TN base station 102 or 104, or the UE 102 operating the idle or inactive state can reselect from the NTN cell 125 to the TN cell 124 or 126.

If the base station 104 is a gNB, the cell 124 is an NR cell. If the base station 104 is an ng-eNB or eNB, the cell 124 is an evolved universal terrestrial radio access (E-UTRA) cell. Similarly, if the base station 106 is a gNB, the cell 126 is an NR cell, and if the base station 106 is an ng-eNB or eNB, the cell 126 is an E-UTRA cell. The cells 124 and 126 can be in the same Radio Access Network Notification Areas (RNA) or different RNAs. In general, the RAN 105 can include any number of terrestrial and non-terrestrial base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

To directly exchange messages or information, the base stations 104, 105, and 106 can support an X2 or Xn interface. In general, the CN 110 can connect to any suitable number of terrestrial and non-terrestrial base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol. The UE 102 may further utilize the techniques of this disclosure when the radio connection between the UE 102 and the RAN 105 is disconnected and operating in a PSM where no radio resource control (RRC) protocol relationship exists between the UE and the network.

The base station 104 is equipped with a transceiver and processing hardware 130 that can include one or more general-purpose processors (e.g., CPUs) and a non-transitory computer-readable memory storing instructions that the one or more general-purpose processors execute. Additional or alternatively, the processing hardware 130 can include special-purpose processing units. The processing hardware 130 in an example implementation includes a processor 132 to process data that the base station 104 will transmit in the downlink direction, or process data received by the base station 104 in the uplink direction. The processing hardware 130 can also include a transmitter 136 configured to transmit data in the downlink direction. The processing hardware further can include a receiver 134 configured to receive data in the uplink direction. The base station 106 can include generally similar components. In particular, components 140, 142, 144, and 146 of the base station 106 can be similar to the components 130, 132, 134, and 136, respectively.

The UE 102 is equipped with a transceiver and processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transmitter 156 configured to transmit data in the downlink direction. The processing hardware further can include a receiver 154 configured to receive data in the uplink direction.

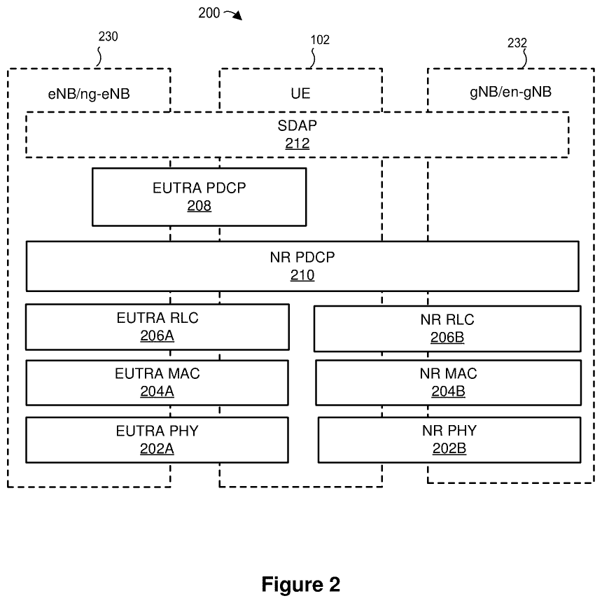

As illustrated in FIG. 2, various functionality can be distributed between the RAN 105 and the 5GC 160, and further distributed between different components of the 5GC 160, such as the AMF 164 and the SMF 166.

In particular, a base station 202 (e.g., the base station 104 or 106) can host the following main functions: Radio Resource Management such as Radio Bearer Control, Radio Admission Control, Connection Mobility Control, dynamic allocation of resources to UEs in both up-link and downlink (scheduling); IP header compression, encryption and integrity protection of data; selection of an AMF at UE attachment when no routing to an AMF can be determined from the information provided by the UE; routing of User Plane data toward the UPF(s); routing of Control Plane information towards the AMF; connection setup and release; scheduling and transmission of paging messages; scheduling and transmission of system broadcast information (originated from the AMF or OAM); measurement and measurement reporting configuration for mobility and scheduling; transport level packet marking in the uplink; session management; support of network slicing; QoS flow management and mapping to data radio bearers; support of UEs in RRC_INACTIVE state; distribution of NAS messages; radio access network sharing; Dual Connectivity; and interworking between NR and E-UTRA.

The AMF 204 can host the following functionality: NAS signaling termination; NAS signaling security; AS security control; inter-CN node signaling for mobility between 3GPP access networks; Idle mode UE Reachability (including control and execution of paging retransmission); Registration Area management; support of intra-system and inter-system mobility; access authentication; access authorization including checking of roaming rights; mobility management control (subscription and policies); support of network slicing; and SMF selection.

The UPF 206 can host the following functionality: anchor point support for Intra-/Inter-RAT mobility (when applicable); external PDU session point of interconnect to data network support; packet routing & forwarding; packet inspection and user plane part of policy rule enforcement; traffic usage reporting; uplink classification to support routing traffic flows to a data network; branching point to support multi-homed PDU session; QoS handling for user plane, e.g. packet filtering, gating, UL/DL rate enforcement; uplink traffic verification (SDF to QoS flow mapping); and downlink packet buffering and downlink data notification triggering.

Finally, the SMF 208 can provide session management; UE IP address allocation and management; selection and control of UP function; configuration of traffic steering at User Plane Function, UPF, to route traffic to proper destination; control of policy enforcement and QoS; and downlink data notification.

FIG. 3A illustrates a certain type of NTN deployment referred to as transparent payload architecture, which involves a satellite gateway 302 and a “transparent” satellite 304 for extending the range of the Uu interface. This NTN deployment may be incorporated into the RAN 105 of FIG. 1A as another base station 105 or an extension of the base station 104 or 106. The satellite 304 implements a frequency conversion and a Radio Frequency (RF) amplifier in both the uplink and downlink directions. The satellite function is similar to that of an analogue RF repeater. Thus, the satellite 304 repeats the Uu radio interface from the feeder link (between the NTN gateway and the satellite) to the service link (between the satellite and the UE) in the downlink direction and vice versa in the uplink direction. The Satellite Radio Interface (SRI) on the feeder link is the Uu, and the NTN gateway 302 supports all necessary functions to forward the signal of the Uu interface. The NTN gateway 302 operates at the same site (location) as the base station (e.g., eNB, gNB) 104, or connects to the base station 104 over a distance via a wired link. It is also possible to connect more than one NTN gateway to a base station. Different transparent satellites may be connected to the same base station on the ground, via the same NTN gateway, or via different NTN gateways.

FIG. 3B illustrates the implementation in which two different satellites (304 and 306) connect to the same base station 104 via the same NTN gateway 302, and these two satellites (304 and 306) are covering the Earth surface using two different Physical Cell IDs (PCIs).

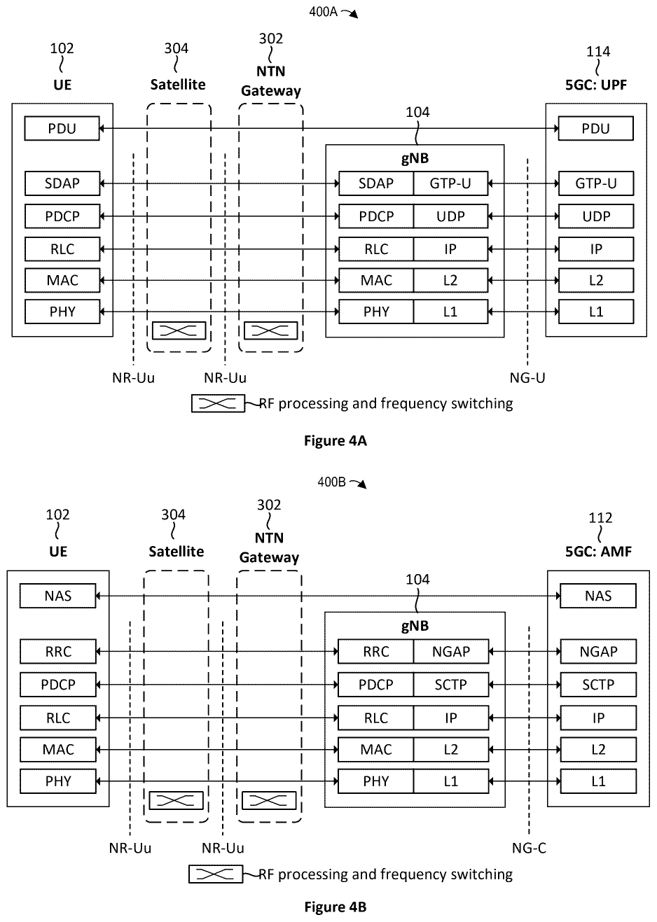

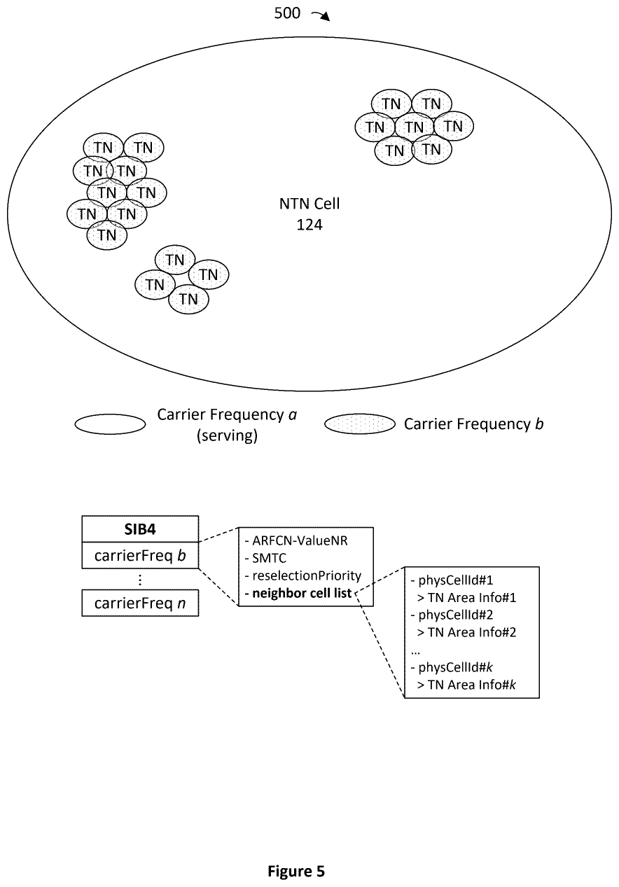

Next, FIG. 4A illustrates an NTN user-plane protocol stack involving the UE 102, the satellite 304, the NTN gateway 302, the base station 104, and the EPC S-GW 112 (or 5GC SMF 166). The NTN user-plane protocol stack is similar to that of the terrestrial network (TN), except that the configuration of FIG. 4A illustrates two additional nodes, the satellite 304 and the NTN gateway 302, operating in the middle of the Uu interface. Similarly, the NTN control plane protocol stack illustrated of FIG. 4B is also generally analogous to that of the terrestrial network counterpart shown in FIG. 2B.

Referring generally to FIGS. 1-4B, NTN supports at least three types of service links NTN, described in terms of satellite movement patterns: (i) Earth-fixed: provisioned by beam(s) continuously covering the same geographical areas all the time (e.g., the case of GEO/GSO satellites); (ii) Quasi-Earth-fixed: provisioned by beam(s) covering one geographic area for a limited period and a different geographic area during another period (e.g., the case of LEO/MEO satellites capable of using steerable beams); and (iii) Earth-moving: provisioned by beam(s) whose coverage area slides over the Earth surface (e.g., the case of LEO/MEO satellites using fixed or non-steerable beams).

With LEO/MEO satellites, a base station can provide either quasi-Earth-fixed cell coverage or Earth-moving cell coverage. With GEO satellites, the base station can provide Earth fixed cell coverage.

Although the transparent payload architecture illustrated in FIGS. 3A and 3B is the current focus of the 3GPP development, the regenerative payload architecture that places some of the base station functions on the satellite is also a possible NTN deployment in the future. In such an architecture, the Uu only exists between the satellite and the UE. In general, the techniques of this disclosure can apply to the transparent payload architecture as well as the regenerative payload architecture.

FIG. 5 illustrates an example scenario 500 in which the network (e.g., the RAN 105 and/or the CN 110) configure UEs to measure TN frequencies associated with TN cells, when the UEs are in the idle or inactive state and are camping on an NTN cell. In this example, there are multiple TN cells within the NTN cell 125, the TN cells are operating using carrier frequency b, and the NTN cell 125 is operating using carrier frequency a. The base station of the NTN cell 125 broadcasts information relevant to the inter-frequency measurement in SIB4, which contains the information the UEs require to conduct the inter-frequency measurement on the carrier frequency b, including the Absolute Radio-Frequency Channel Number (ARFCN) value of the carrier frequency b, an SSB Measurement Timing Configuration (SMTC), the cell reselection priority of the carrier frequency b, and a neighbor cell list listing the physical cell identities of the neighboring TN cells using carrier frequency b. Assuming the cell reselection priority of carrier frequency b is higher than that of the serving frequency (i.e., carrier frequency a), the UE in the idle/inactive state in some of the implementations conducts the measurement on the carrier frequency b.

To allow a UE to forego the measurement on carrier frequency b when the UE is not in the vicinity of any TN cells, and thus save power and time, the base station of the NTN cell 125 can provide the TN coverage information in the System Information (SI). In one implementation, the base station provides the TN coverage information (e.g., the TN Area Info in FIG. 5) for each TN cell in the neighbor cell list in SIB4. In another implementation, the base station provides the TN coverage information in a separate list and may not be TN cell-specific. The UE camping on the NTN cell 125 first processes SIB4 and determines from the ARFCN value whether carrier frequency b is a TN or an NTN frequency. If the carrier frequency is a TN frequency, the UE may need to obtain from the neighbor cell list or from a separate TN coverage information list, the TN coverage information (e.g., TN Area Info in FIG. 5) of carrier frequency b. The UE then can determine whether (and how) to conduct the measurement on carrier frequency b, based on whether the UE is within or in the vicinity of any TN cell coverage. The UE also can determine whether (and how) to conduct measurements on a specific TN cell listed in the neighbor cell list, based on whether the UE is within or in the vicinity of that TN cell.

However, as illustrated in FIG. 5, the base station of the NTN cell 125 must broadcast the coverage information for every TN cell (20 TN cells in this example) within the NTN cell coverage, which may make SIB4 exceed the size limit, when there are numerous TN cells within the NTN cell coverage.

To reduce the signaling overhead due to detailed cell coverage information discussed above, the base station 105 or another suitable base station provides coarse, or more abstract, TN coverage information instead of detailed TN coverage information, in the NTN cell. The coarse TN coverage information indicates the TN coverage at a coarser level but requires much less bandwidth to convey in a system information block or otherwise provide in the NTN cell. The coarse TN coverage information can indicate a segment into which the base station and the UE can logically divide the NTN cell. For example, the base station 105 and the UE 102 can have a shared understanding that the substantially circular coverage area of the NTN cell 125 includes N circular sectors of equal size, with the left boundary of sector #0 aligned with the True North direction, and the subsequent sector forming a sequence in the clockwise direction.

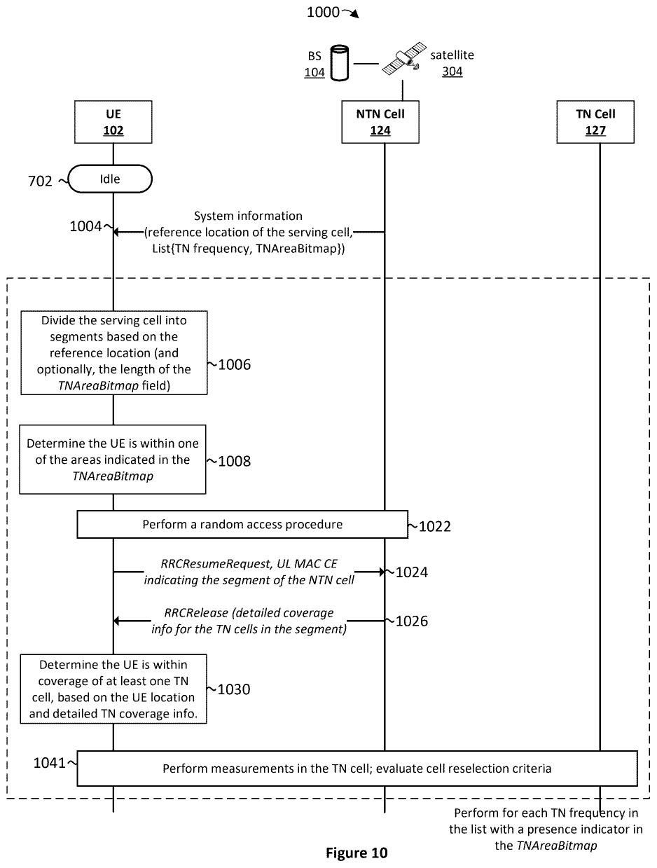

Using the coarse TN coverage information, the UE can reduce its power consumption in certain situations. In some implementations, the UE can obtain the detailed TN coverage information from the base station, as discussed with reference to FIGS. 10-12 for example.

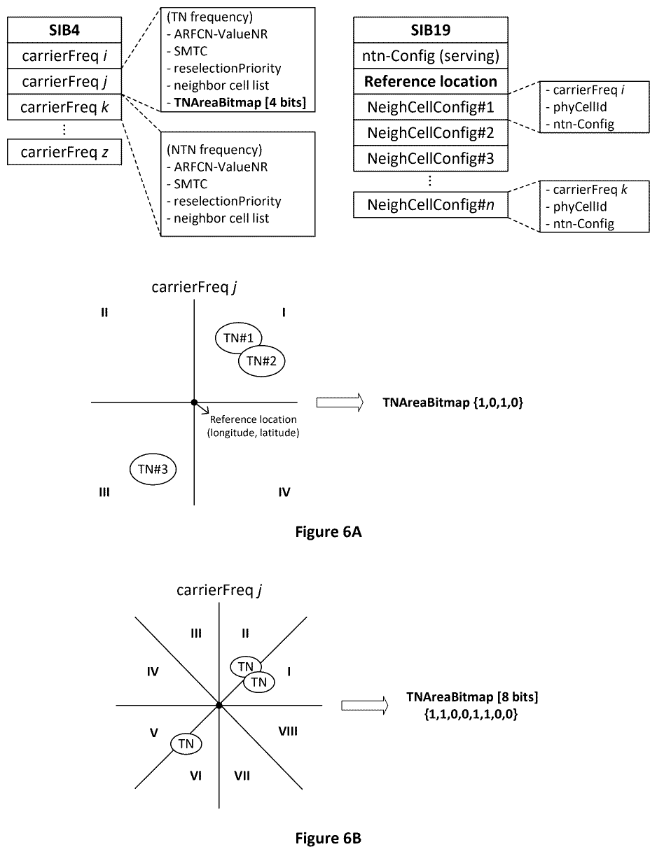

As illustrated in FIG. 6A, each TN carrier frequency (e.g., carrier frequency j) configuration listed in SIB4 includes a 4-bit long TNAreaBimap, associated with that carrier frequency. The 4-bit TNAreaBitmap indicates whether there is any TN cell deployed in the four equal-size areas into which the base station and the UE divide the NTN cell using the reference location, which the base station can provide in SIB19. The four areas are labeled as Area I, II, III, and IV, and are mapped to the 1^{st} bit, 2^{nd} bit, 3^{rd} bit, and 4^{th} bit in the TNAreaBitmap, respectively. In the example illustrated in FIG. 6A, as there are two TN cells deployed in Area I, and one TN cell deployed in Area III, the values within the TNAreaBitmap are {1, 0, 1, 0}. For those NTN frequency configurations (e.g., carrier frequency k) listed in SIB4, they do not need to include the TNAreaBitmap. A UE can determine whether a carrier frequency listed in SIB4 is a TN or an NTN frequency from: (1) the ARFCN value, or (2) whether the same carrier frequency can be also found in the neighbor cell configuration in SIB19. If a UE determines that a carrier frequency listed in SIB4 is a TN frequency, the UE can expect to receive a TNAreaBitmap associated with the carrier frequency in SIB4. When the UE cannot find a TNAreaBitmap in the configuration of a TN frequency in SIB4, the UE may not be allowed to modify (or relax) the measurement on that TN frequency, i.e., the UE must to comply with the default measurement requirement while conducting the measurement on that TN frequency.

In another implementation, the NTN cell in FIG. 6B is divided into 8 equal-sized areas instead of 4, in accordance with the reference location of the NTN cell 124. Therefore, the length of the TNAreaBitmap become 8 bits, in which each bit indicates whether there is any TN cell deployed in the corresponding area. In this example, as there is (are) TN cell(s) deployed in the Area I, II, V, and VI, the values within the TNAreaBitmap are {1, 1,0,0,1,1,0,0}. In other implementations, an NTN cell can be divided into any number of equal-sized areas, in accordance with the reference location. In such implementations, the length of the TNAreaBitmap can be equal to the number of areas dividing the NTN cell.

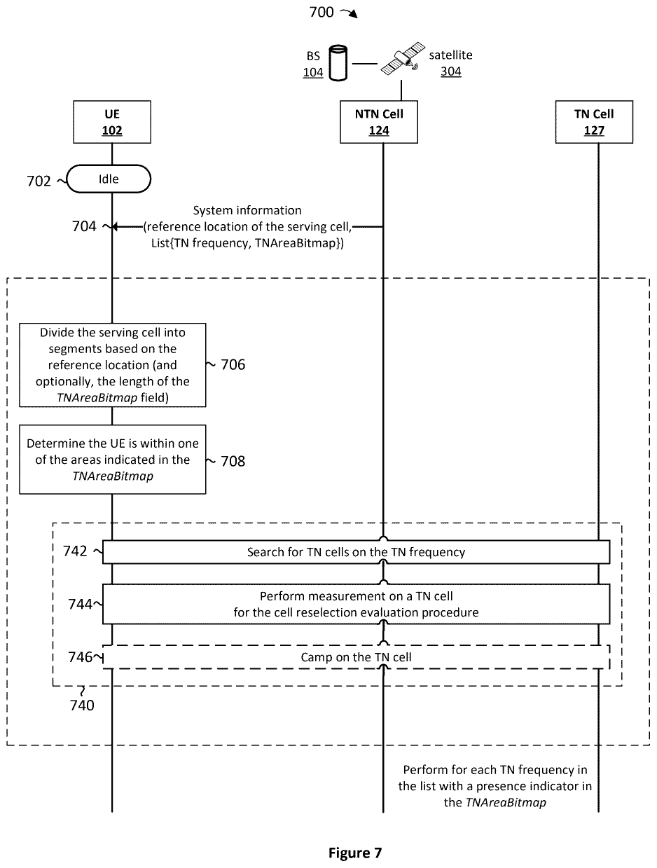

Next, several example scenarios in which a UE and/or a RAN perform the techniques of this disclosure for supporting NTN-to-TN mobility in the idle or inactive state with enhanced UE power saving are discussed with reference to FIGS. 7-12. Generally speaking, similar events in FIGS. 7-12 are labeled with the similar reference numbers, with differences discussed below where appropriate. For example, event 708 is similar to event 808, and event 742 is similar to event 942. To simplify the following description, the term “idle state” is used and can represent the RRC_IDLE or the RRC_INACTIVE state, and the term “connected state” is used and can represent the RRC_CONNECTED state.

FIG. 7 is a messaging diagram 700 of an example demonstrating how a UE in the idle state triggers the measurement on a TN carrier frequency or on a TN cell in NTN, when the UE may be close to a TN cell operating in that carrier frequency. In FIG. 7, UE 102 initially camps on the NTN Cell 124 managed by the BS 104 through the satellite 304, where the NTN cell 124 covers another TN cell 127 within its coverage. While remaining 702 in the idle state, the UE 102 receives 704, in the NTN Cell 124, a first system information message including a reference location and a list of the pair {TN frequency, TNAreaBitmap}, where the list of the pair {TN frequency, TNAreaBitmap} can be conveyed in the list of the frequency configurations in SIB4.

In response to the first system information message, the UE 102 applies the following actions/steps, for each of the TN frequencies listed in the first system information message.

The UE 102 divides 706 the NTN Cell 124 into regions/areas, for instance, 4 equal-sized regions/areas, based on the reference location. The way the UE 102 uses to divide an NTN serving cell into equal-sized areas can be a fixed rule defined in the specification. For instance, the UE 102 always divides an NTN serving cell into 4 areas, separated by the parallel and the meridian crossing at the reference location of the serving cell. The way the UE 102 divides an NTN serving cell can be dynamically based on the length of the TNAreaBitmap associated to the TN frequency. For instance, the UE 102 can divide an NTN serving cell into n equal-sized areas, if the length of the TNAreaBitmap associated to the TN frequency equals to n bits.

After that, the UE 102 determines which area (the divided areas aforementioned) it is in by comparing its GNSS coordinate with the latitude and longitude of the reference location, and then determines 708 the area it falls within is denoted by value ‘1’ (i.e., TN cell exists) in the TNAreaBitmap. Since the area the UE 102 falls within has the TN cell deployed, the UE 102 searches 742 for the TN cells on the TN frequency, and then may detect the TN Cell 127. Once the UE 102 detects the TN Cell 127, the UE 102 needs to perform 744 the necessary and regular measurement on TN Cell 127, for the cell reselection evaluation procedure. At a later time, UE 102 may need to reselect and camp 746 to the TN Cell 127, if the cell reselection criteria are fulfilled for the TN Cell 127. The events 742, 744, and optionally 746 are collectively referred to in FIG. 7 as a procedure for conducting measurement on the TN frequency/cells and evaluating the cell reselection criteria.

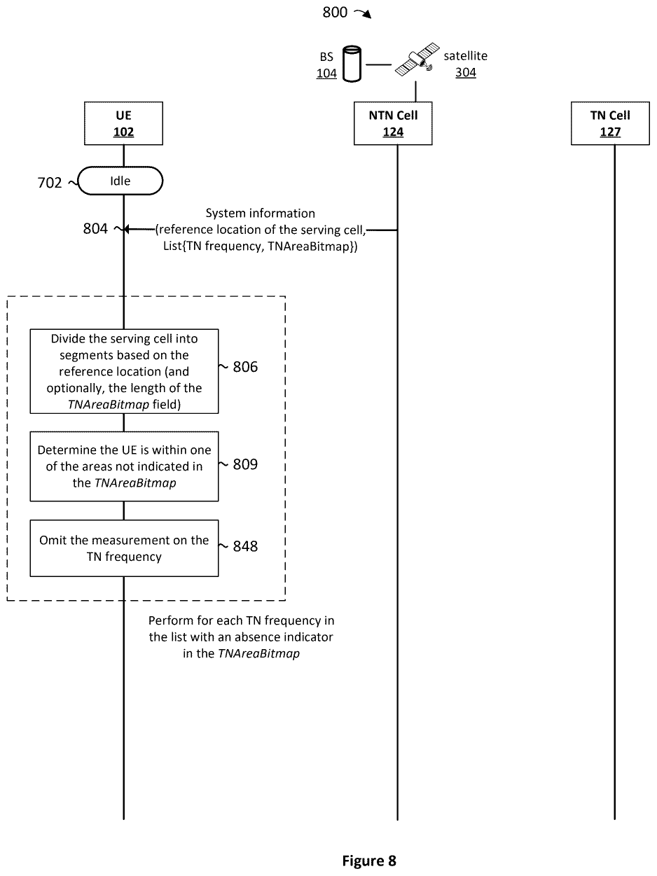

FIG. 8 is a messaging diagram 800 of an example demonstrating how a UE in the idle state determines NOT to measure a TN carrier frequency or a TN cell in NTN, when the UE is not close to a TN cell operating in that carrier frequency. The message diagram in FIG. 8 is similar to that in FIG. 7, with the differences discussed below. In FIG. 8, after dividing 706 the NTN Cell 124 into regions/areas, the UE 102 determines 808 the area it falls within is denoted by value ‘0’ (i.e., no TN cell nearby) in the TNAreaBitmap. In response to the determination, the UE 102 determines 848 NOT to conduct the measurement on the TN frequency.

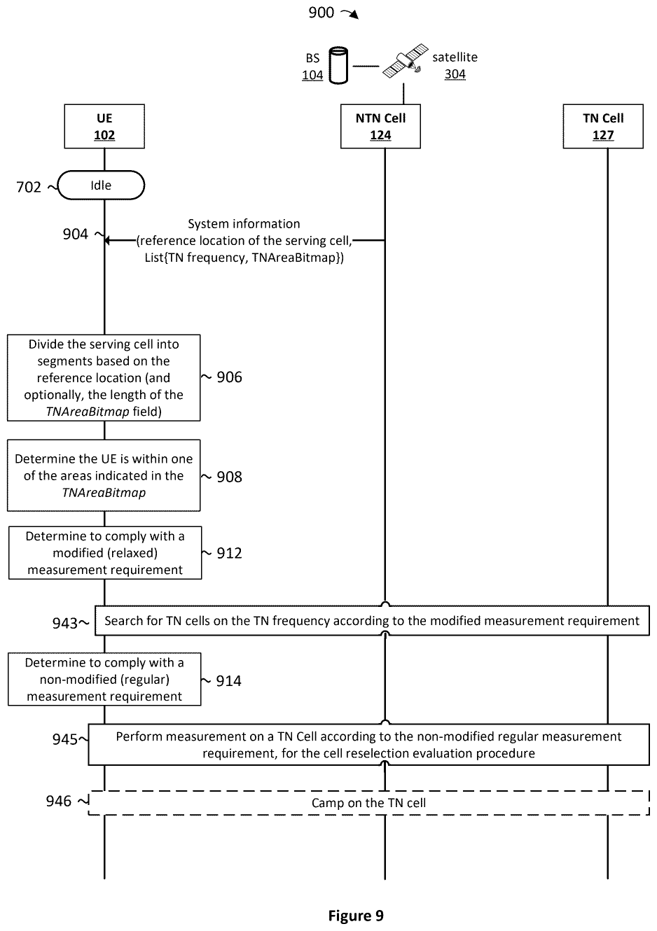

FIG. 9 is a messaging diagram 900 of an example demonstrating how a UE in the idle state triggers the relaxed measurement on a TN carrier frequency or on a TN cell in NTN, when the UE may be close to a TN cell operating in that carrier frequency. The message diagram in FIG. 9 is similar to that in FIG. 7, with the differences discussed below. In FIG. 9, after determining 708 that the area it falls within is denoted by value ‘1’ (i.e., TN cell exists) in the TNAreaBitmap, the UE 102 determines 912 to comply with a relaxed measurement requirement, where the relaxed measurement requirement allows the UE 102 to conduct the measurement with a longer interval. For instance, the regular NR measurement requirement consists of three parameters that UE needs to fulfill in terms of measuring inter-frequency cells: T_{detect,NR_Inter}, T_{measure,NR_Inter}, and T_{evaluation,NR_Inter}. The definitions of T_{detect,NR_Inter}, T_{measure,NR_Inter}, and T_{evaluation,NR_Inter} can be found in 3GPP TS 38.133 (v17.7.0). On the other hand, the relaxed NR measurement requirement consists of another three parameters that UE needs to fulfill in terms of measuring inter-frequency cells: TR_{detect,NR_Inter}, TR_{measure,NR_Inter}, and TR_{evaluation,NR_Inter}, where TR_{detect,NR_Inter}=T_{detect,NR_Inter}*C, TR_{measure,NR_Inter}=T_{measure,NR_Inter}*C, and TR_{evaluation,NR_Inter}=T_{evaluation,NR_Inter}*C. C is a constant (integer or non-integer) value larger than one.

After that, the UE 102 searches 942 for the TN cells on the TN frequency based on the relaxed measurement requirement, and then may detect the TN Cell 127. Once the UE 102 detects the TN Cell 127, the UE 102 determines 914 to comply with a regular (i.e., NOT relaxed) measurement requirement, and then performs 744 the necessary and regular measurement on TN Cell 127, for the cell reselection evaluation procedure. At a later time, UE 102 may need to reselect and camp 746 to the TN Cell 127, if the cell reselection criteria are fulfilled for the TN Cell 127.

FIG. 10 is a messaging diagram 1000 of an example demonstrating how a UE in the idle state acquires detailed TN coverage information using a RRC resume procedure, when the UE may be close to a TN cell operating in that carrier frequency. The message diagram in FIG. 10 is similar to that in FIG. 7, with the differences discussed below. In FIG. 10, after determining 708 that the area it falls within is denoted by value ‘1’ (i.e., TN cell exists) in the TNAreaBitmap, the UE 102 conducts 1022 either a 2-step or a 4-step random access (RA) procedure to obtain an UL grant (in case of 4-step RA) or an PUSCH resource (in case of a 2-step RA), and then transmits 1024 a RRC Resume Request message (e.g., a RRCResumeRequest or a RRCResumeRequest1 message) together with a UL MAC CE containing a bit string of the same size as TNAreaBitmap, and indicating which area the UE 102 is within.

In response to the RRC Resume Request message together with the UL MAC CE, the BS 104 transmits a RRC Release message including the detailed coverage information of the TN cells in that area. The detailed coverage information may contain a reference location (e.g., a cell center coordinate) and a cell radius/cell diameter/distance threshold for each TN cell. Upon receiving the RRC Release message, the UE 102 remains in the idle state and then determines 1030 whether the UE 102 is within the coverage of at least one TN cell, based on the UE location and detailed TN coverage information. As in this example the UE 102 is within the cell coverage of the TN Cell 127, the determination in event 1030 is positive; therefore, the UE 102 performs 740 the procedure for conducting measurement on the TN frequency/cells and evaluating the cell reselection criteria.

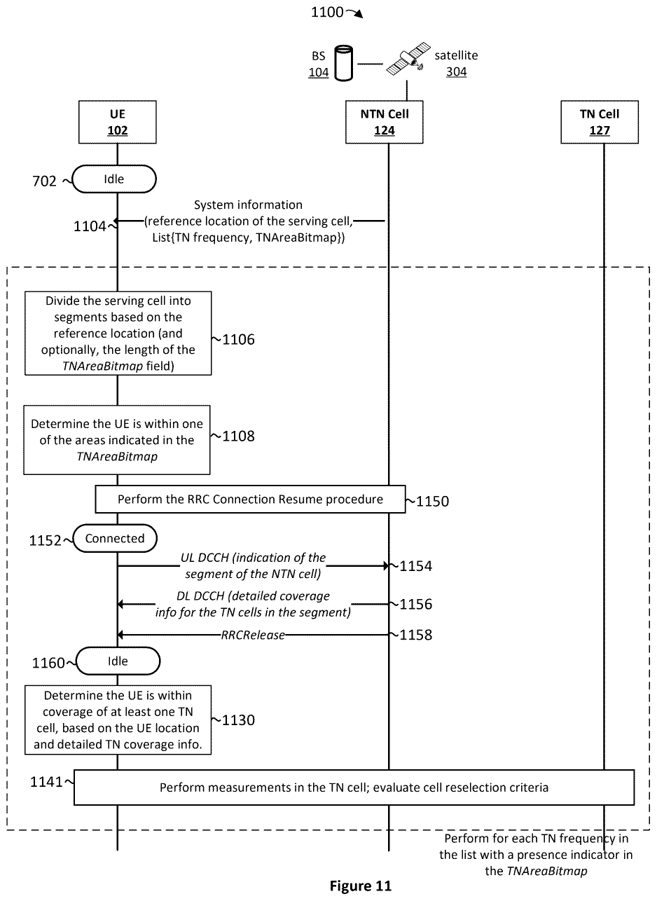

FIG. 11 is a messaging diagram 1100 of an example demonstrating how a UE in the idle state resumes its RRC connection and acquires detailed TN coverage information, when the UE may be close to a TN cell operating in that carrier frequency. The message diagram in FIG. 11 is similar to that in FIG. 7, with the differences discussed below. In FIG. 11, after determining 708 that the area it falls within is denoted by value ‘1’ (i.e., TN cell exists) in the TNAreaBitmap, in one implementation, the UE 102 conducts 1150 a RRC Connection Resume procedure with the BS 104 via the NTN Cell 124, and therefore transitions 1152 into the connected state; in another implementation, the UE performs a RRC Connection Establishment procedure and a Security Command procedure with the BS 104 via the NTN Cell 124, and then transitions into the connected state.

After transitioning into the connected state, the UE 102 transmits 1154 an UL DCCH (Dedicated Control Channel) message containing a bit string of the same size as TNAreaBitmap and indicating which area the UE 102 is within. Note that the UE 102 may attempt to acquire an UL grant (e.g., performs SR or BSR) before transmitting the UL DCCH message. In response to the UL DCCH message, the BS 104 transmits 1156 a DL DCCH message including the detailed coverage information of the TN cells in that area. The detailed coverage information may contain a reference location (e.g., a cell center coordinate) and a cell radius/cell diameter/distance threshold for each TN cell. At a later time, the BS transmits 1158 a RRC Release message to the UE 102 upon the expiry of a RRC inactivity timer (i.e., no traffic occurred between the UE 102 and the BS 104 for a while).

Upon receiving the RRC Release message, the UE 102 transitions 1160 into the idle state and then determines 1030 whether the UE 102 is within the coverage of at least one TN cell, based on the UE location and detailed TN coverage information. As in this example the UE 102 is within the cell coverage of the TN Cell 127, the determination in event 1030 is positive; therefore, the UE 102 performs 740 the procedure for conducting measurement on the TN frequency/cells and evaluating the cell reselection criteria.

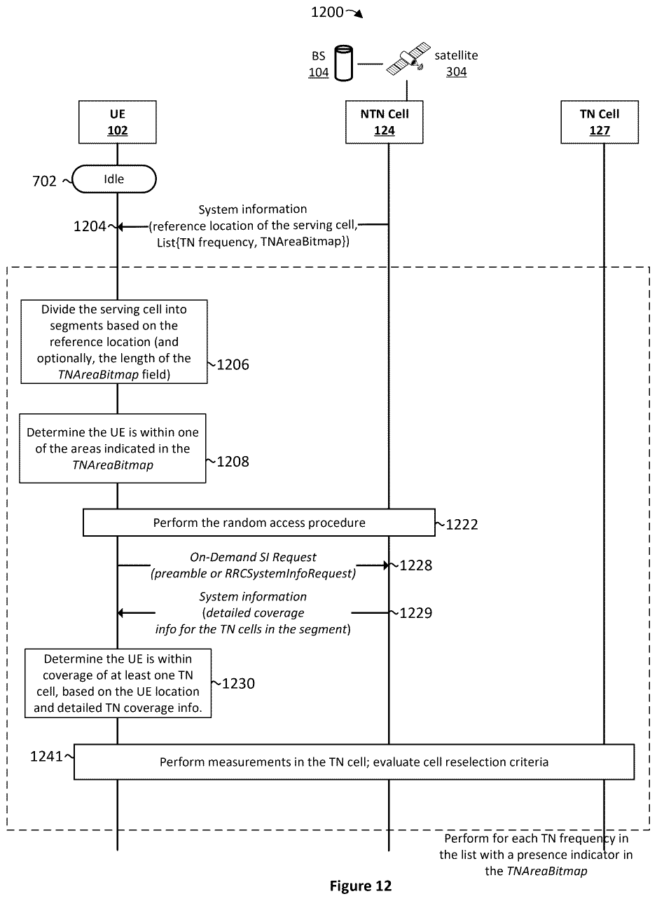

FIG. 12 is a messaging diagram 1200 of an example demonstrating how a UE in the idle state acquires detailed TN coverage information using an on-demand SI acquisition procedure, when the UE may be close to a TN cell operating in that carrier frequency. The message diagram in FIG. 12 is similar to that in FIG. 7, with the differences discussed below. In FIG. 12, after determining 708 that the area it falls within is denoted by value ‘1’ (i.e., TN cell exists) in the TNAreaBitmap, the UE 102 conducts 1228 either a 2-step or a 4-step random access (RA) procedure to initiate an on-demand SI acquisition procedure. The UE 102 may either transmit a dedicated preamble or transmit a RRC System Information Request message after obtaining an UL grant/a PUSCH resource through the RA procedure, to indicate a desired SI message. In this example, the desired SI message is the SI message including the detailed coverage information of the TN cell(s) in a specific area or within the entire coverage of the NTN cell 124. Upon receiving the desired SI message, the UE 102 determines 1030 whether the UE 102 is within the coverage of at least one TN cell, based on the UE location and detailed TN coverage information. As in this example the UE 102 is within the cell coverage of the TN Cell 127, the determination in event 1030 is positive; therefore, the UE 102 performs 740 the procedure for conducting measurement on the TN frequency/cells and evaluating the cell reselection criteria.

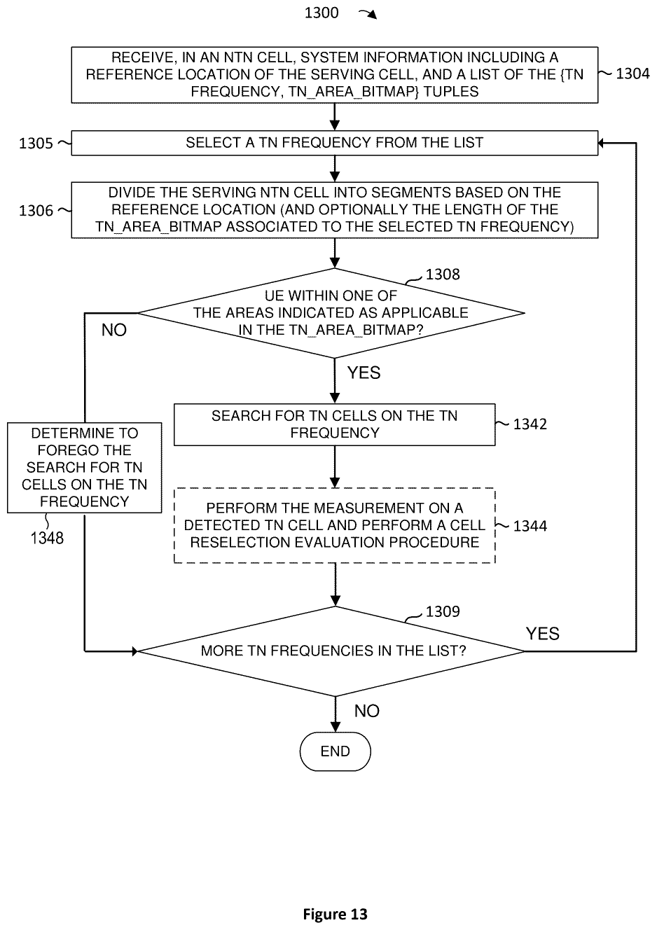

FIG. 13 is a flow diagram of an example method 1300 that can be implemented by a UE (e.g., UE 102 in this disclosure) in the idle state, for determining whether to conduct the measurement on a TN carrier frequency in NTN, based on the coarse TN coverage information. Initially, at block 1304, the UE receives from a BS via a satellite payload, system information including a reference location of the serving cell, and a list of the following pair: {TN frequency, TNAreaBitmap}. Then, the flow proceeds to the block 1305, where the UE picks, from the listed TN frequencies, a TN frequency. After that, the UE divides, at block 1306, the serving cell, into areas based on the reference location of the serving cell and optionally the length of the TNAreaBitmap associated to the picked TN frequency.

The flow then proceeds to the decision block 1308, where the UE determines whether the UE is within one of the areas having the value ‘1’ in the TNAreaBitmap associated to the picked TN frequency.

If the determination at block 1308 is ‘YES’ (i.e., UE is within one of the areas having the value ‘1’ in the TNAreaBitmap), the flow proceeds to the block 1342, where the UE searches for the cells on the TN frequency UE picked. In case the UE detects any TN cell operating in that TN frequency, the UE may perform 1344 the measurement on the detected TN cell(s), for the cell reselection evaluation procedure. After that, the flow proceeds to the decision block 1309. Note that if the UE finds any of the detected TN cells fulfilling the cell reselection criteria after conducting 1344 the necessary measurement on the detected TN cells, the UE may camp to one of the TN cells fulfilling the cell reselection criteria, which leads the entire procedure to the end.

On the other hand, if the determination at block 1308 is ‘NO’ (i.e., UE is NOT within one of the areas having the value ‘1’ in the TNAreaBitmap), the flow proceeds to the block 1348, where the UE determines NOT to search for the cells on the picked TN frequency, and then the flow proceeds to the decision block 1309.

In the decision block 1309, the UE checks whether there is any TN frequency still listed in SIB4 and not picked by the UE yet. If there is still at least one TN frequency not picked by the UE (i.e., the YES branch following the decision block 1309), the flow loops back to the block 1305. Otherwise (the NO branch following the decision block 1309), the flow proceeds to the block 1398, which marks the end of the entire procedure.

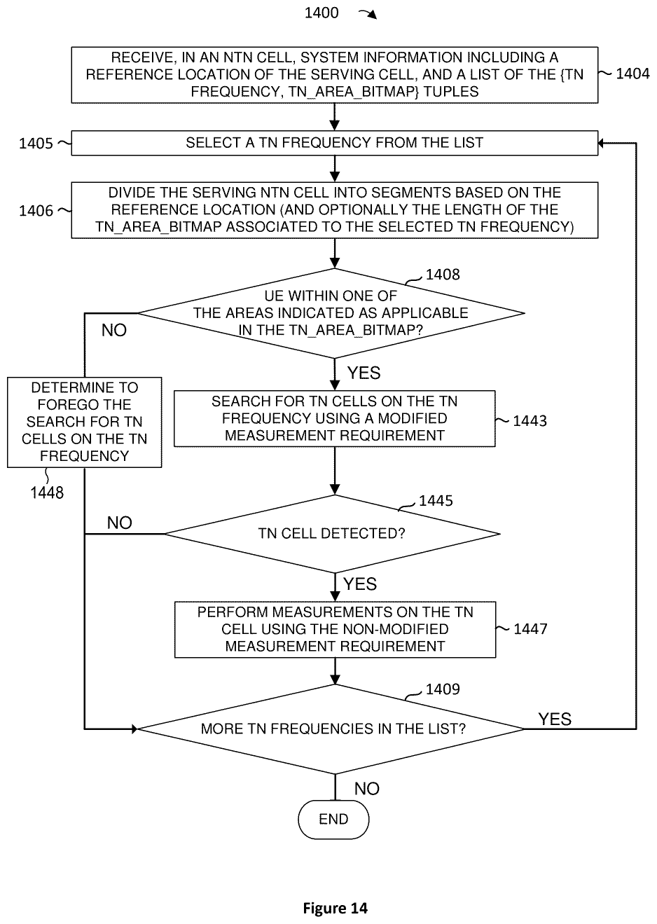

FIG. 14 is a flow diagram of an example method 1400 that can be implemented by a UE (e.g., UE 102 in this disclosure) in the idle state, for determining whether to conduct the relaxed measurement on a TN carrier frequency in NTN, based on the coarse TN coverage information. The flow diagram in FIG. 14 is similar to that in FIG. 13, with the differences discussed below. In FIG. 14, if the determination at block 1308 is ‘YES’ (i.e., UE is within one of the areas having the value ‘1’ in the TNAreaBitmap), the flow proceeds to the block 1412, where the UE determines to comply with a relaxed measurement requirement while measuring any TN frequency/cell. Then the UE searches, at block 1442, for the cells on the TN frequency UE picked at block 1305, based on the relaxed measurement requirement.

After that, the flow proceeds to another decision block 1443, where the UE determines whether the UE has detected any TN cell while searching for the cells on the TN frequency at block 1442. If the UE has detected at least one TN cell (i.e., the YES branch following the decision block 1443), the UE determines, at block 1414, to comply with a regular measurement requirement while measuring any TN frequency/cell, and then performs, at block 1344, the necessary measurement on the detected TN cell(s) for the cell reselection evaluation procedure. However, if the UE has NOT detected any TN cell (i.e., the NO branch following the decision block 1443), the flow skips the block 1414 and 1344, and proceeds directly to the final decision block 1309, where the UE checks whether there is any TN frequency still listed in SIB4 and not picked by the UE yet.

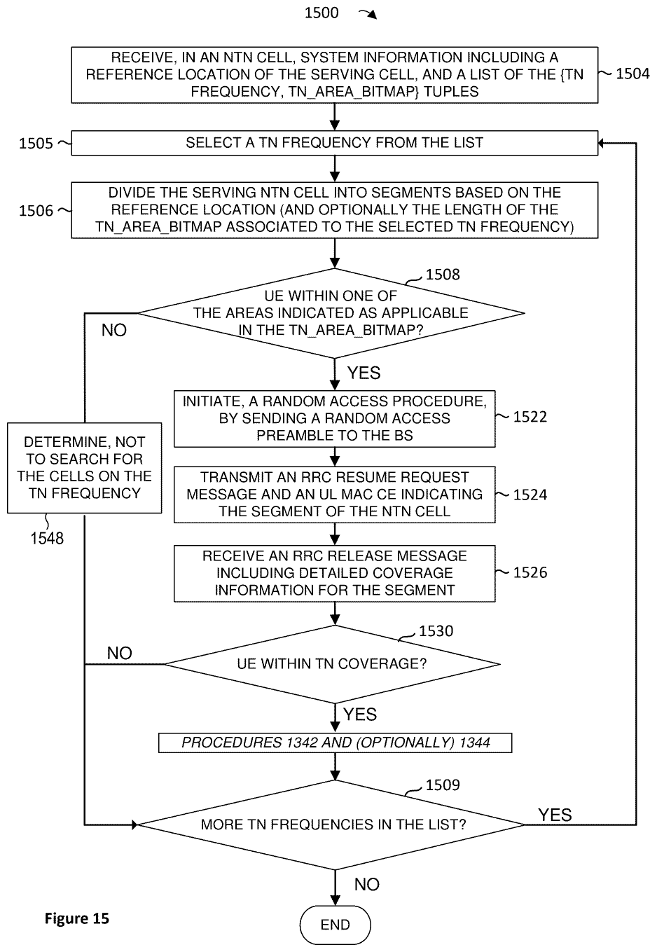

FIG. 15 is a flow diagram of an example method 1500 that can be implemented by a UE (e.g., UE 102 in this disclosure) in the idle state, for determining whether to acquire detailed TN coverage information using a RRC resume procedure. The flow diagram in FIG. 15 is similar to that in FIG. 13, with the differences discussed below. In FIG. 15, if the determination at block 1308 is ‘YES’ (i.e., UE is within one of the areas having the value ‘1’ in the TNAreaBitmap), the flow proceeds to the block 1522, where the UE initiates, a random access procedure by sending a random access preamble to the BS. Then the UE transmits, at block 1524, to the base station, a RRC Resume Request Message plus an UL MAC CE indicating the area the UE is within, using the random access procedure initiated at block 1522. After that, the UE receives, at block 1526, from the base station, a RRC release message including the detailed TN coverage information of the indicated area. The detailed TN coverage information may contain a reference location (e.g., a cell center coordinate) and a cell radius/cell diameter/distance threshold for each TN cell.

After that, the flow proceeds to another decision block 1530, where the UE determines whether the UE is within any TN coverage, based on the UE location information and the detailed TN coverage information obtained at block 1526. If the is within any TN coverage (i.e., the YES branch following the decision block 1530), the UE searches, at block 1342, for the cells on the TN frequency UE picked, and may perform, at block 1344, the necessary measurement on the detected TN cell(s), for the cell reselection evaluation procedure. However, if the UE is NOT within any TN coverage (i.e., the NO branch following the decision block 1530), the flow skips the block 1342 and 1344, and proceeds directly to the final decision block 1309, where the UE checks whether there is any TN frequency still listed in SIB4 and not picked by the UE yet.

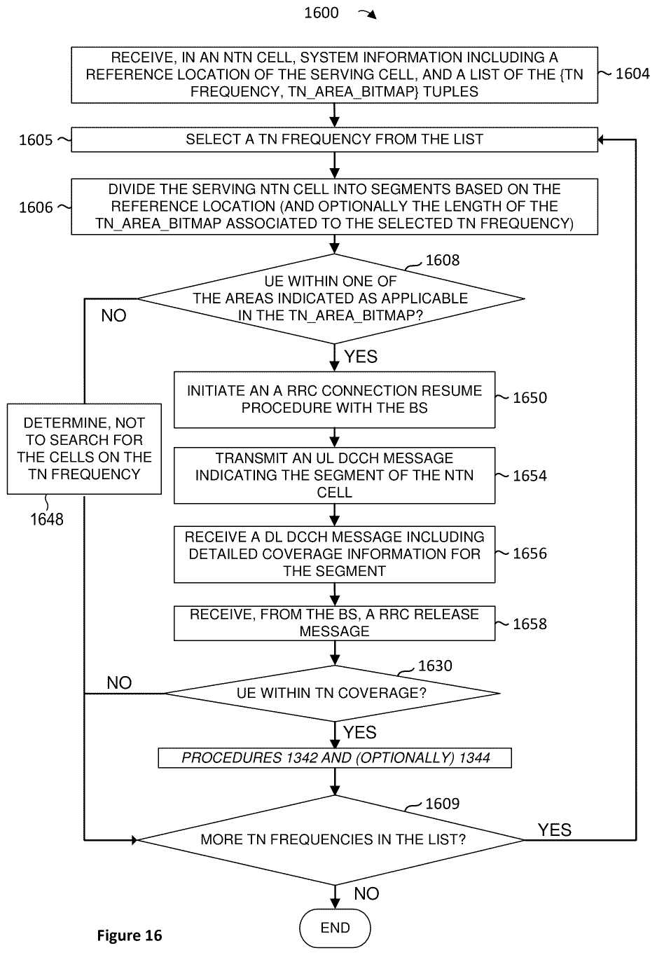

FIG. 16 is a flow diagram of an example method 1600 that can be implemented by a UE (e.g., UE 102 in this disclosure) in the idle state, for determining whether to resume its RRC connection and acquire detailed TN coverage information. The flow diagram in FIG. 16 is similar to that in FIG. 15, with the differences discussed below. In FIG. 16, if the determination at block 1308 is ‘YES’ (i.e., UE is within one of the areas having the value ‘1’ in the TNAreaBitmap), the flow proceeds to the block 1650, where the UE initiates, a RRC Connection Resume procedure by sending a RRC Resume Request message to the BS. Upon receiving a RRC Resume message from the BS and transitioning into the connected state, the UE transmits, at block 1654, to the BS, an UL DCCH message indicating the area the UE is within. After that, the UE receives, at block 1656, from the BS, a DL DCCH message including the detailed TN coverage information of the indicated area. The detailed TN coverage information may contain a reference location (e.g., a cell center coordinate) and a cell radius/cell diameter/distance threshold for each TN cell. At a later time, the UE receives, at block 1658, from the BS, a RRC Release message that transitions the UE into the idle state again. The rest of the procedure is the same as that in FIG. 15.

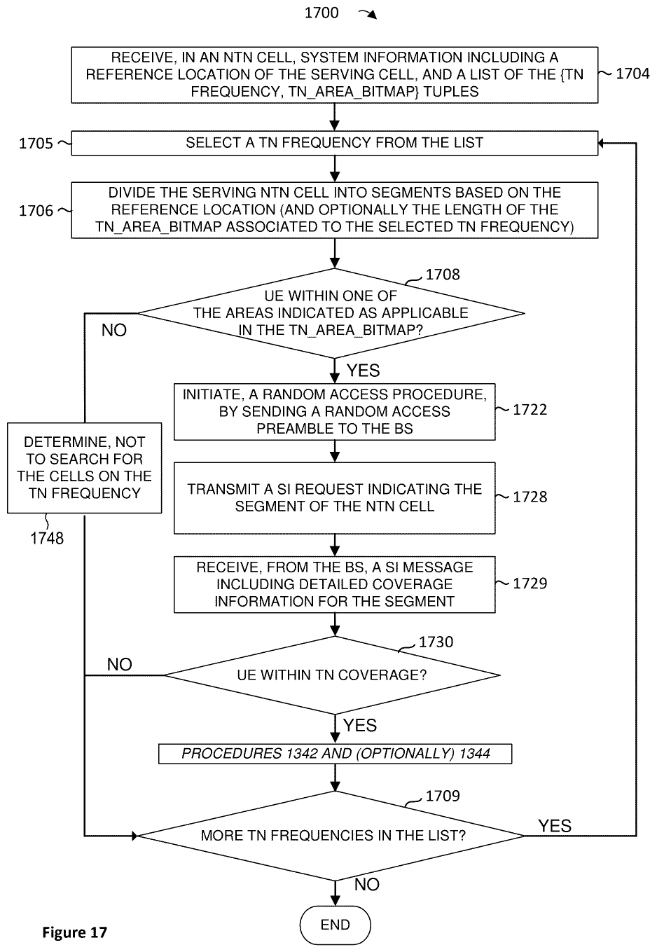

FIG. 17 is a flow diagram of an example method 1700 that can be implemented by a UE (e.g., UE 102 in this disclosure) in the idle state, for determining whether to acquire detailed TN coverage information using an on-demand SI acquisition procedure. The flow diagram in FIG. 17 is similar to that in FIG. 15, with the differences discussed below. In FIG. 17, if the determination at block 1308 is ‘YES’ (i.e., UE is within one of the areas having the value ‘1’ in the TNAreaBitmap), the flow proceeds to the block 1522, where the UE initiates a random access procedure by sending a random access preamble to the BS. Then the UE transmit, at block 1728, to the BS, a SI request message for requesting the detailed TN coverage information of the area the UE is within or is interested in, using the random access procedure initiated at block 1522. After that, the UE receives, at block 1729, from the BS, a SI message including at least the detailed TN coverage information of the indicated area. The SI message received at block 1729 may also include the detailed TN coverage information of other areas that UE is not within or is not interested in. The detailed TN coverage information may contain a reference location (e.g., a cell center coordinate) and a cell radius/cell diameter/distance threshold for each TN cell. The rest of the procedure is the same as that in FIG. 15.

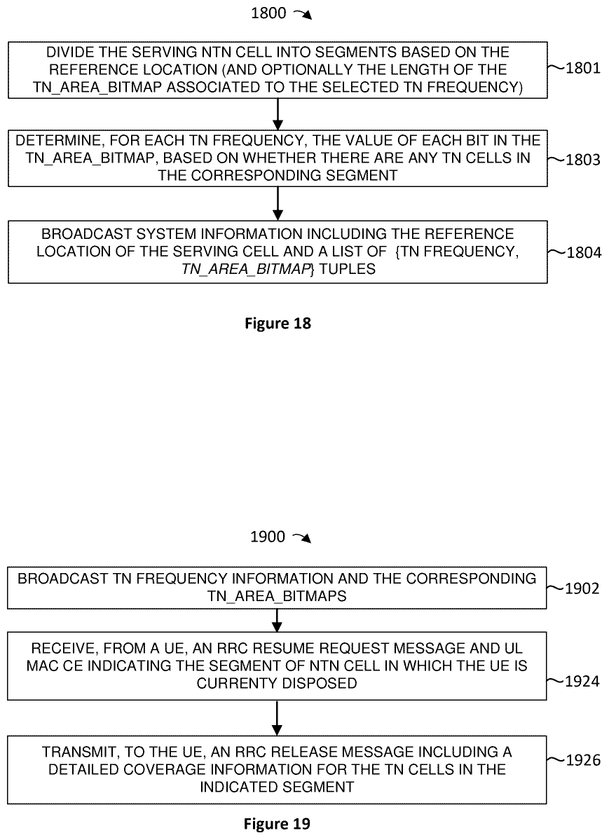

FIG. 18 is a flow diagram of an example method 1800 that can be implemented by a BS (e.g., BS 104 in this disclosure), for determining the coarse TN coverage information and broadcasting it in the system information. Initially, at block 1801, the BS divides, the serving cell, into areas based on the reference location and optionally the length of TNAreaBitmap. The number of areas being divided can be a fixed number predefined in the specification or can be a dynamic number aligning the length of the TNAreaBitmap. In one implementation, the BS divides the serving cell into areas with the edges crossing at the reference location.

At block 1803, the BS determines, for each TN frequency, the value of each bit in the associated TNAreaBitmap, based on whether there is any TN cell in the corresponding areas that the BS has divided at block 1801. After the BS has determined the TNAreaBitmap values for each TN frequency, the BS broadcasts, at block 1804, a system information including the reference location of the serving cell, and a list of the following pair: {TN frequency, TNAreaBitmap}.

FIG. 19 is a flow diagram of an example method 1900 that can be implemented by a BS (e.g., BS 104 in this disclosure), for delivering detailed TN coverage information to the UE in a RRC Resume procedure. The method 1900 can be executed after the method 1800 by the BS. After executing the method 1800, the BS receives, at block 1924, from the UE, a RRC Resume Request message plus an UL MAC CE indicating the area the UE is within. In response to the RRC Resume Request message and the UL MAC CE, the BS transmits, at block 1926, to the UE, a RRC Release Message including the detailed coverage information of the TN cells in the indicated area. The detailed coverage information may contain a reference location (e.g., a cell center coordinate) and a cell radius/cell diameter/distance threshold for each TN cell.

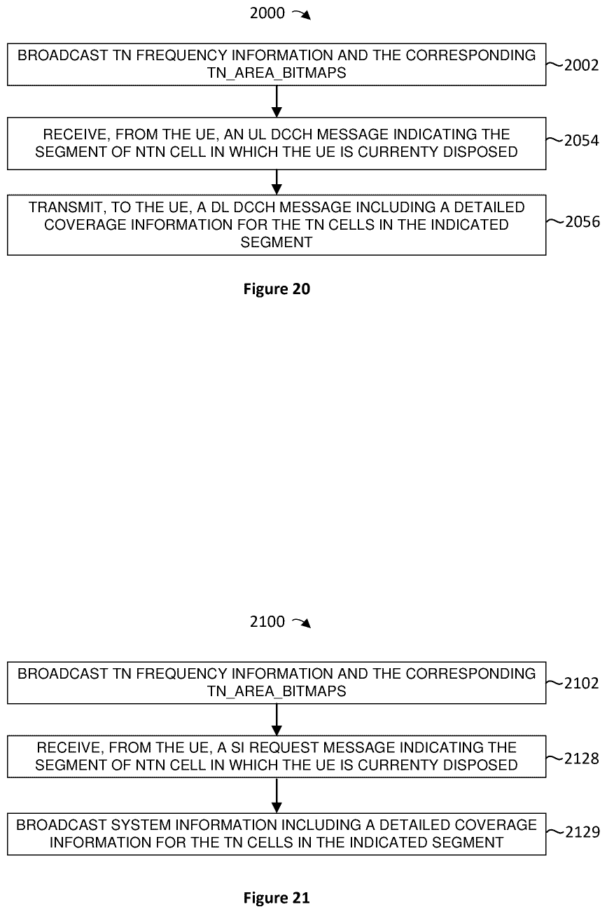

FIG. 20 is a flow diagram of an example method 2000 that can be implemented by a BS (e.g., BS 104 in this disclosure), for delivering detailed TN coverage information to the UE in a DL DCCH message. The method 2000 can be executed after the method 1800 by the BS. After executing the method 1800, the BS receives, at block 2054, from the UE, an UL DCCH Message indicating the area the UE is within. In response to the UL DCCH message, the BS transmits, at block 2056, to the UE, a DL DCCH Message including the detailed coverage information of the TN cells in the indicated area. The detailed coverage information may contain a reference location (e.g., a cell center coordinate) and a cell radius/cell diameter/distance threshold for each TN cell.

FIG. 21 is a flow diagram of an example method 2100 that can be implemented by a BS (e.g., BS 104 in this disclosure), for broadcasting detailed TN coverage information in an on-demand system information. The method 2100 can be executed after the method 1800 by the BS. After executing the method 1800, the BS receives, at block 2128, from the UE, a SI request message asking the detailed TN coverage information of a specific area or asking the detailed TN coverage information without indicating a specific area. In response to the SI request message, the BS broadcasts, at block 2129, to UEs, a system information including the detailed TN coverage information of at least the area enquired by the UE. The BS may broadcast, at block 2129, a system information including the detailed TN coverage information of every TN cell within the NTN cell. The detailed coverage information may contain a reference location (e.g., a cell center coordinate) and a cell radius/cell diameter/distance threshold for each TN cell.

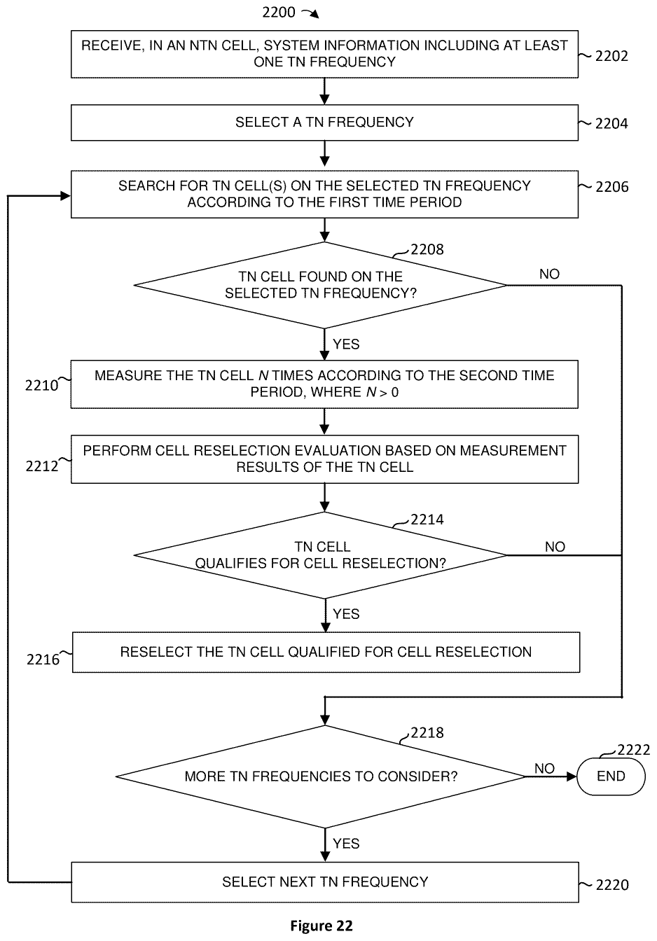

FIG. 22 illustrates an example method 2200, which can be implemented by a UE (e.g., the UE 102), for communicating with a RAN (e.g., the RAN 105, base station 104, 106 or DU 174).

The method 2200 begins at block 2202, where the UE receives, from a base station via a satellite on an NTN frequency, system information including at least one TN frequency (e.g., event 704). At block 2204, the UE selects one of the at least one TN frequency. At block 2206, the UE searches for TN cell(s) on the picked TN frequency once every first time period. At block 2208, the UE determines whether the UE finds a TN cell on the picked TN frequency. If the UE determines that the UE fines a TN cell on the picked carrier frequency, the flow proceeds to block 2210. At block 2210, the UE measures the TN cell N times every second time period, where N>0. At block 2212, the UE performs cell reselection evaluation based on measurement results of the TN cell. At block 2214, the UE determines whether the TN cell qualifies for cell reselection. If the UE determines that the TN cell qualifies for cell reselection at block 2214, the flow proceeds to block 2216, where the UE reselects the TN cell qualified for cell reselection. Otherwise, if the UE determines that the TN cell does not qualify for cell reselection at block 2214, the flow proceeds to block 2218. At block 2218, the UE determines whether there is a remaining TN frequency in the at least one TN frequency that has not been selected by the UE yet. If the UE determines that there is a TN frequency that has not been selected by the UE at block 2218, the flow proceeds to block 2220. At block 2220, the UE selects the TN frequency and the flow proceeds to block 2206. Otherwise, if the UE determines that there is no TN frequency that has not been selected by the UE at block 2218, the flow proceeds to block 2222, where the flow ends. If the UE determines that the UE does not find a TN cell at block 2208, the flow proceeds to block 2218.

In some implementations, the first and second time periods are different. For example, the first time period is longer than the second time period. In other implementations, the first and second time periods are the same. In such cases, N can be larger than one.

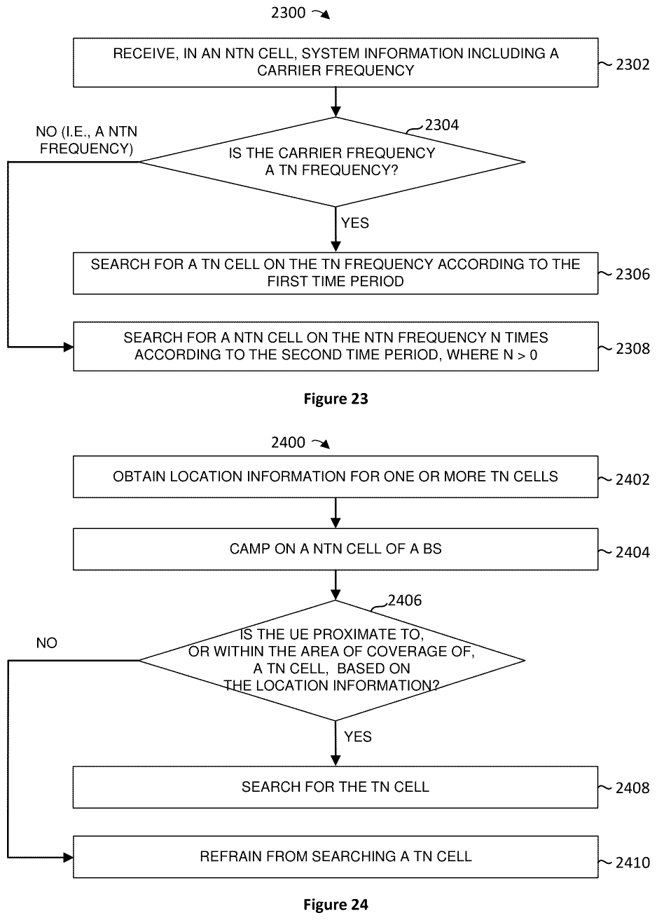

FIG. 23 illustrates an example method 2300, which can be implemented by a UE (e.g., the UE 102), for communicating with a RAN (e.g., the RAN 105, base station 104, 106 or DU 174).

The method 2300 begins at block 2302, where the UE receives, from a base station via a satellite on an NTN frequency, system information including a carrier frequency (e.g., event 704). At block 2304, the UE determines whether the frequency is a TN frequency. If the UE determines that the carrier frequency is a TN frequency at block 2304, the flow proceeds to block 2306. At block 2306, the UE searches for a TN cell on the TN frequency once every first time period. Otherwise, if the UE determines that the carrier frequency is an NTN frequency at block 2304, the flow proceeds to block 2308. At block 2308, the UE searches for an NTN cell on the NTN frequency once every second time period.

In some implementations, the first and second time periods are different. For example, the first time period is longer than the second time period. In other implementations, the first and second time periods are the same. In such cases, N can be larger than one.

FIG. 24 illustrates an example method 2400, which can be implemented by a UE (e.g., the UE 102), for communicating with a RAN (e.g., the RAN 105, base station 104, 106 or DU 174).

The method 2400 begins at block 2402, where the UE obtains location information for one or more TN cells. At block 2404, the UE camps on an NTN cell of a BS. At block 2406, the UE determines whether the UE is close to or in coverage of a TN cell based on the location information. If the UE determines that the UE is close to or in coverage of a TN cell based on the location information at block 2406, the flow proceeds to block 2408. At block 2408, the UE searches for the TN cell. The UE can search for the TN cell while camping on the NTN cell. Otherwise, if the UE determines that the UE is not close to and/or in coverage of a TN cell based on the location information at block 2406, the flow proceeds to block 2410. At block 2410, the UE refrains from searching for a TN cell. The UE can refrain from searching for the TN cell while camping on the NTN cell.

In some implementations, the UE receives the location information of TN cell(s) from a core network via a RAN (e.g., a TN cell or an NTN cell (e.g., the NTN cell in block 2404 or another NTN cell)), while operating in a connected state (e.g., RRC_CONNECTED state). The UE can receive one or more dedicated messages including the location information from the core network via the RAN. In other implementations, the UE receives the location information of TN cell(s) from the RAN. In one implementation, the UE receives the location information of TN cell(s) via system information from the RAN (e.g., event 704). In another implementation, the UE receives the location information of TN cell(s) via one or more dedicated message from the RAN, while operating in the connected state. In some implementations, the location information includes GNSS coordinate(s). In such cases, each of the GNSS coordinate(s) is/are associated with a particular TN cell.

In other implementations, the UE can obtain its GNSS coordinate(s) by using a GNSS receiver, while camping on the one or more TN cell(s). For example, while the UE camping on a TN cell, the UE uses its GNSS receiver to receive GNSS signals, derive a GNSS coordinate, associate the GNSS coordinate with the TN cell, and store the GNSS coordinate and a cell ID of the TN cell in a storage. The cell ID can be a physical cell identity.

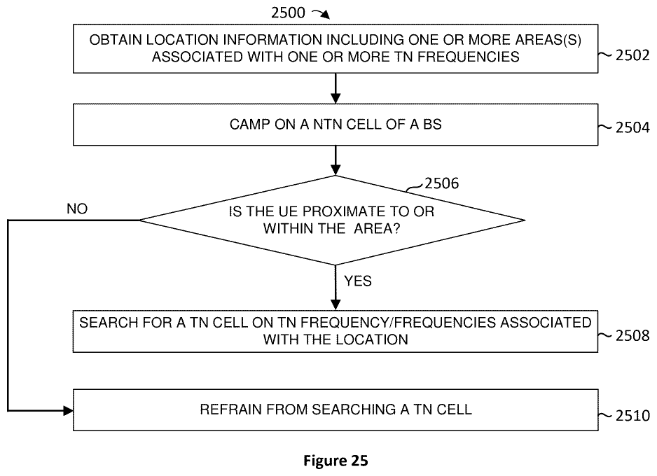

FIG. 25 illustrates an example method 2500, which can be implemented by a UE (e.g., the UE 102), for communicating with a RAN (e.g., the RAN 105, base station 104, 106 or DU 174).

The method 2500 begins at block 2502, where the UE obtains location information including one or more location(s) associated with one or more TN frequencies. At block 2504, the UE camps on an NTN cell of a BS. At block 2506, the UE determines whether the UE is close to or in a location of the one or more locations. If the UE determines that the UE is close to or in a location of the one or more locations at block 2506, the flow proceeds to block 2508. At block 2508, the UE searches for a TN cell on TN frequency/frequencies associated with the location. The UE can search for a TN cell on the on TN frequency/frequencies while camping on the NTN cell. Otherwise, if the UE determines that the UE is not close to and/or in a location based on the location information at block 2506, the flow proceeds to block 2510. At block 2510, the UE refrains from searching for a TN cell. The UE can refrain from searching for a TN cell while camping on the NTN cell.

In some implementations, the UE receives the location information from a core network via a RAN (e.g., a TN cell or an NTN cell (e.g., the NTN cell in block 2504 or another NTN cell)), while operating in a connected state (e.g., RRC_CONNECTED state). The UE can receive one or more dedicated messages including the location information from the core network via the RAN. In other implementations, the UE receives the location information from the RAN. In one implementation, the UE receives the location information via system information from the RAN (e.g., event 704). In another implementation, the UE receives the location information via one or more dedicated message from the RAN, while operating in the connected state. In some implementations, the location information includes GNSS coordinate(s). In such cases, each of the GNSS coordinate(s) is/are associated with a particular TN frequency.

In other implementations, the UE can obtain the GNSS coordinate(s) by using a GNSS receiver, while camping on one or more TN cell(s) of the one or more TN frequencies. For example, while the UE camping on a TN cell, the UE uses its GNSS receiver to receive GNSS signals, derive a GNSS coordinate, associate the GNSS coordinate with a TN frequency of the TN cell, and store the GNSS coordinate and an ID of the TN frequency in a storage. The ID can be an Absolute Radio Frequency Channel Number (ARFCN).

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “some” means “one or more”. In some implementations, “at least one” means “one or more”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1-18. (canceled)

19. A method for inter-frequency measurements performed by a user equipment (UE), the method comprising:
receiving, via a non-terrestrial network (NTN) cell, a reference location of the NTN cell and one or more pairs of
a terrestrial network (TN) frequency, and
a bitmap indication identifying one or more of a plurality of segments of the NTN cell with which the TN frequency is associated, the plurality of segments being determined by dividing the NTN cell in N sectors around the reference location, when the bitmap indication includes N bits; and
searching for a TN cell on the TN frequency only if a current location of the UE is within the one or more of the plurality of segments with which the TN frequency is associated according to the bitmap indication.

20. The method of claim 19, wherein each of the N bits of the bitmap indication corresponds to one of the plurality of segments of the NTN cell.

21. The method of claim 20, wherein the one or more pairs are received in a system information block (SIB).

22. The method of claim 19, wherein the searching for the TN cell on the TN frequency includes performing longer inter-frequency measurements.

23. The method of claim 22, wherein the longer inter-frequency measurements result from an increased duration of at least one of T_{detect,NR_Inter}, T_{measure,NR_Inter}, Or T_{evaluate,NR_Inter}, which are defined for inter-frequency measurements of Next Radio cells in 3GPP technical specifications.

24. The method of claim 19, further comprising:
transmitting, to a base station associated with the NTN cell, an indication of the current location of the UE.

25. The method of claim 24, wherein the transmitting of the indication includes transmitting one of:
a request to resume a radio connection with the base station,
an uplink dedicated control channel message, or
an on-demand system information request.

26. The method of claim 24, further comprising:
receiving, from the base station, coverage information for the TN cell,
wherein the searching for the TN cell includes using the coverage information.

27. The method of claim 26, wherein the receiving of the coverage information includes receiving one of:
a command to release the radio connection,
a downlink dedicated control channel message, or
a system information message.

28. The method of claim 26, wherein the coverage information for the TN cell includes at least one of a reference location of the TN cell, or a radius of the TN cell.

29. A user equipment comprising:
a transceiver configured to wirelessly communicate via terrestrial network cells and non-terrestrial network cells; and
a processing component configured
to receive, via a non-terrestrial network (NTN) cell, a reference location of the NTN cell and one or more pairs of
a terrestrial network (TN) frequency, and
a bitmap indication identifying one or more of a plurality of segments of the NTN cell with which the TN frequency is associated,
the plurality of segments being determined by dividing the NTN cell in N sectors around the reference location, when the bitmap indication includes N bits; and
to selectively search for a TN cell on the TN frequency only if a current location of the UE is within the one or more of the plurality of segments with which the TN frequency is associated according to the bitmap indication.

30. The user equipment of claim 29, wherein the processing component is further configured to performing longer inter-frequency measurements by increasing duration of at least one of T_{detect,NR_Inter}, T_{measure,NR_Inter}, or T_{evaluate,NR_Inter}, which are defined for inter-frequency measurements of Next Radio cells in 3GPP technical specifications.

31. A method for configuring UE inter-frequency measurements, performed by a base station associated with a non-terrestrial network (NTN) cell, the method comprising:
transmitting, to at least one UE in the NTN cell, a reference location of the NTN cell and one or more pairs of a terrestrial network (TN) frequency, and a bitmap indication identifying one or more of a plurality of segments of the NTN cell with which the TN frequency is associated, to facilitate a UE search for a TN cell on the TN frequency,
wherein the plurality of segments is determined by dividing the NTN cell in N sectors around the reference location, when the bitmap indication includes N bits.

32. The method of claim 31, wherein each of the N bits corresponds to a respective one of the plurality of segments of the NTN cell.

33. The method of claim 31, wherein the one or more pairs are transmitted in a system information block.

34. The method of claim 31, further comprising:
receiving, from the UE, an indication of a current location of the UE.

35. The method of claim 34, wherein:
the receiving of the indication includes receiving one of (i) a request to resume a radio connection with the base station, (ii) an uplink (UL) Dedicated Control Channel (DCCH) message and (iii) an on-demand system information (SI) request, and

36. The method of claim 34, further comprising:
transmitting coverage information for a specific TN cell within one of the plurality of segments of the NTN cell where the UE is currently located according to the indication.

37. The method of claim 36, wherein:
the transmitting of the coverage information includes transmitting a command to release the radio connection, a downlink dedicated control channel message, or an system information message.

38. A base station comprising:
a transceiver configured to wirelessly communicate with user equipment via a non-terrestrial network (NTN) cell; and
a processing component configured to transmit, to at least one UE in the NTN cell, a reference location of the NTN cell and one or more pairs of a terrestrial network frequency, and a bitmap indication identifying one or more of a plurality of segments of the NTN cell with which the TN frequency is associated, to facilitate a UE search for a TN cell on the TN frequency,
the plurality of segments being determined by dividing the NTN cell in N sectors around the reference location, when the bitmap indication includes N bits.
